(19) United States
(12) Patent Application Publication
(10) Pub. No.: US 2010/0185411 A1
(43) Pub. Date: Jul. 22, 2010

(54) OBJECT MONITOR

(76) Inventors: Randall Richard Pfeiffer, Davis, CA (US); Niromi Leelamani Wijewantha, Davis, CA (US)

Correspondence Address: DAVID E. LOVEJOY, REG. NO. 22,748, 102 REED RANCH ROAD, TIBURON, CA, 94920-2025, US

(21) Appl. No.: 12/355,427

(22) Filed: Jan. 16, 2009

(51) Int. Cl. G06F 15/00; G08B 21/00

(52) U.S. Cl. 702/150; 340/686.1

(57) ABSTRACT

An object monitor including two or more sensors for detecting two or more objects on two or more paths. Each sensor operates to detect location values of an object traveling along one of the paths. A processor receives first location values of a first object and calculates a first arrival time of the first object at a collision point. The processor receives second location values of a second object and calculates a second arrival time of the second object at the collision point. The processor operates to provide an alarm signal when the first arrival time and the second arrival time are within a safety difference value of being equal.

### BACKGROUND OF THE INVENTION

This invention relates to monitors for monitoring the location of and movement of objects in environments where the objects might encounter congestion or collide. The monitors operate to warn of and help avoid such potential collisions and congestion.

Collisions and congestion potentially can occur between and among many types of moving objects. Such objects include people that are walking, people on gurneys, people in wheel chairs or people that are otherwise mobile. Such objects also include golf carts, bicycles, cars, trucks and other vehicles. The environment for potential collisions often exists at locations where one moving object does not have an adequate line-of-sight view of another object. For example, where one travel path for one object intersects the travel path of another object at a blind corner, the possibility of collisions and congestion of the objects approaching the corner results.

Environments for congestion and potential collisions are widely present. Blind corners exist in hospitals, schools, homes, stores, parking garages, roadways and other locations where moving objects travel.

In potential congestion and collision environments, curved mirrors commonly are mounted so that people and other “objects” approaching a blind intersection can “see” and avoid others approaching a potential collision. Mirrors and other passive devices, however, require the attention and vigilance of the concerned parties in order to avoid collision. In emergency and other situations, attention of people is often diverted or distracted and therefore passive devices have not been fully effective in achieving collision avoidance and the avoidance of the adverse affects of congestion.

There are a number of existing technologies that are employed in monitoring objects. Such technologies, for example, produce ultrasonic pulses, radar pulses and other signals that measure the reflected intensity and delay of echo signals to determine the existence of and distance to oncoming pedestrian, vehicular traffic or other objects.

One typical device for monitoring position and movement of objects is the GE RCR-50 sensor. The GE sensor is a range-controlled radar motion sensor that uses a combination of controlled Doppler effect radar and passive infrared (PIR). A range setting from 9 to 50 feet allows the sensor to detect objects from a specific area and ignore objects outside the covered range, if desired. The sensor determines the attributes of an object by calculating its size and distance away from the sensor at each instance in time. The GE sensor is one of many active devices that sense motion and location.

Another typical device for monitoring position and movement of objects is the Air Ultrasonic sensor including the Air Ultrasonic Ceramic Transducer 400ST/R160 transmitter/receiver pair. The transmitter/receiver pair operates at 40 KHz (ultrasonic). The transmitter/receiver pair operates in an object monitor with conventional circuitry, including analog/digital converters and a microprocessor, and the resulting ultrasonic object monitor is capable of distance ranges of up to about 22 feet, ranges sufficient for many applications.

While the GE and Air Ultrasonic sensors and other active sensor devices sense motion and location, they do not provide information about possible and projected collisions and congestion.

In consideration of the above background, there is a need for improved monitors for monitoring the location and movement of objects and for determining projected collisions and congestion.

### SUMMARY

The present invention is an object monitor including two or more sensors for detecting two or more objects on two or more paths. Each sensor operates to detect location values of an object traveling along one of the paths. A processor receives first location values of a first object and calculates a first arrival time of the first object in a congestion region such as at a collision point. The processor receives second location values of a second object and calculates a second arrival time of the second object in the congestion region such as at the collision point. The processor operates to provide an alarm signal when the first arrival time and the second arrival time are within a safety difference value of being equal.

In some embodiments, the two or more sensors include two or more fields of view where the two or more fields of view are oriented at different angles relative to each other. In some embodiments, the monitor is hinged to allow sensors to be oriented in different directions for different applications. The different directions provide field-of-view angles anywhere from 0 degrees to 360 degrees. For example, an intermediate angle of approximately 45 degrees is used where two paths to be monitored intersect at 45 degrees.

In some embodiments, the sensors include a first sensor having a first field of view for viewing along a first path and a second sensor having a second field of view for viewing along a second path oriented approximately 90 degrees relative to the first path.

In some embodiments, the sensors include a first sensor having a first field of view for viewing along a first path, a second sensor having a second field of view for viewing along a second path and a third sensor having a third field of view for viewing along a third path where the second path is oriented approximately 90 degrees relative to the first path and the third path is oriented approximately 90 degrees relative to the second path.

In some embodiments, the sensors include a first sensor having a first field of view for viewing along a first path, a second sensor having a second field of view for viewing along a second path, a third sensor having a third field of view for viewing along a third path and a fourth sensor having a fourth field of view for viewing along a fourth path where the second path is oriented at a first angle relative to the first path, the third path is oriented at a second angle relative to the second path and the fourth path is oriented at a third angle relative to the third path.

In some embodiments, the first angle, the second angle and the third angle are approximately 90 degrees.

In some embodiments, the monitor includes memory for storing control data and wherein the processor accesses the control data for controlling the operation of the monitor.

In some embodiments, the monitor includes a control for determining which ones of the two or more sensors provide the first location values and the second location values.

In some embodiments, the monitor includes memory for storing association control data and wherein the processor accesses the association control data for determining which ones of the two or more sensors provide the first location values and the second location values.

In some embodiments, one or more sensors include an ultrasonic transmitter and receiver for transmitting ultrasonic pulses to an object and for receiving reflected ultrasonic pulses from the object.

In some embodiments, one or more sensors include a radar transmitter and receiver for transmitting radar pulses to an object and for receiving reflected radar pulses from the object.

In some embodiments, the sensors are oriented for detecting objects traveling in the same direction along a common path where line-of-sight views are restricted.

In some embodiments, the common path is a curved.

In some embodiments, the sensors are oriented for detecting objects traveling in a hallway and for detecting objects in a room for entering the hallway.

In some embodiments, an alarm intensity changes as a function of the difference value.

In some embodiments, each sensor is assigned a different warning priority.

In some embodiments, the monitor includes a memory for storing control routines and wherein the processor calls the control routines for controlling monitor operation.

In some embodiments, the processor determines the presence of other monitors and adjusts the time of detections to avoid interference with the other monitors.

In some embodiments, the processor determines the presence of other monitors and adjusts a detection duration to provide a uniquely identifiable signal to avoid interference with the other monitors.

Many environments exist where the object monitor detects when objects might collide or might otherwise interfere with each other and such objects include people and vehicles at “blind” corners where two or more objects are coming from directions that prevent them from “seeing” each other. The object monitor initiates audible, visible and/or other alarms to warn of the impending collision or interference.

In some embodiments, the object monitor comprises a sensor for detecting location values of an object traveling along a path and a processor for receiving location values of the object and calculating an arrival time of the object in a congestion region and for providing an alarm signal when the arrival time is equal to a difference value.

The foregoing and other objects, features and advantages of the invention will be apparent from the following detailed description in conjunction with the drawings.

### BRIEF DESCRIPTION OF THE DRAWINGS

FIG. 1 depicts an object monitor located in a potential congestion and collision environment at the intersection of a first and a second hallway or other travel paths.

FIG. 2 depicts a block diagram representation of one embodiment of the object monitor of FIG. 1.

FIG. 3 depicts a plurality of object monitors located in a plurality of potential congestion and collision environments.

FIG. 4 depicts a plurality of object monitors located in a spiral ramp typical of automobile parking garages with many potential congestion and collision environments.

FIG. 5 depicts a top sectional view of the spiral ramp of FIG. 4.

FIG. 6 depicts a top sectional view representative the locations of a first set of sensors in the spiral ramp sectional view of FIG. 5.

FIG. 7 depicts a top sectional view representative the locations of a second set of sensors in the spiral ramp sectional view of FIG. 5.

FIG. 8 depicts a block diagram representation of another embodiment of the object monitor of FIG. 1.

FIG. 9 depicts a block diagram representation of an object monitor having a common processor with a plurality of sensors.

FIG. 10 depicts a block diagram representation of a plurality of object monitors located in a hallway.

FIG. 11 depicts a block diagram representation of a plurality of object monitors located in doorways to rooms along a hallway.

### DETAILED DESCRIPTION

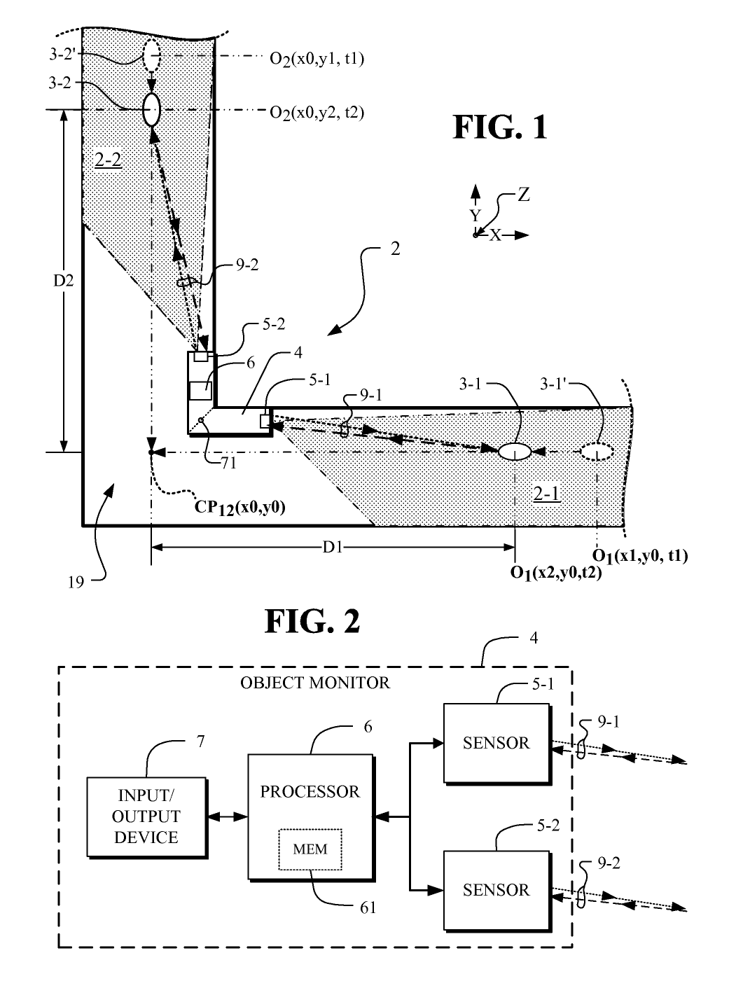

FIG. 1 depicts an object monitor 4 located in a potential congestion and collision environment. The object 3-1 and object 3-2 might collide if they continue along their travel paths to the intersection 19. The intersection 19 is a congestion region located at the juncture of a first passageway 2-1 and a second passageway 2-2 that are part of a hallway or other travel path 2. The travel path 2 can be located in many environments and is representative of virtually every hospital, workplace, school, home or other facility that has hallway corners. The two hallways 2-1 and 2-2 intersect in a manner that prevents approaching pedestrians or other moving objects from “seeing” each other.

In FIG. 1, it is assumed that the objects 3-1′ and 3-2′ are moving toward the blind intersection 19 and hence are in an environment where congestion or a collision can occur. The objects 3-1′ and 3-2′ are representative of any moving objects such as people that are walking, people on gurneys, people in wheel chairs or people that are otherwise mobile in hallways, in elevators or other environments where visibility is impaired. The objects 3-1′ and 3-2′ also are representative of moving objects such as golf carts, bicycles, cars, trucks and other vehicles in environments where visibility is impaired.

In the first passageway 2-1, an object 3-1′ is assumed to be moving at a first velocity in the minus X-axis direction along a first path toward the object 3-1 new location. Initially at t1 time, the object 3-1′ has coordinates x1, y0 and the object and coordinates are designated as O₁(x1, y0, t1). After moving and at a time t2, the object previously at the object 3-1′ location has moved to the object 3-1 location. At the object 3-1 location, the coordinates are x2, y0 and the object and coordinates are designated as O₁(x2, y0, t2). With such designations, the change in position from the object 3-1′ location to the object 3-1 location is measured as (x2−x1) and that change in position occurs over the time interval (t2−t1). The object O₁ continues to travel along the first travel path toward the congestion region designated as the intersection 19 and hence toward the collision point, CP₁₂(x0, y0). The object O₁ will arrive at the collision point, CP₁₂(x0, y0) after traveling the distance D1 where D1 is measured by (x2−x0). The time of arrival, T₁, of the object O₁ at the collision point, CP₁₂(x0, y0), is estimated based upon the speed, S₁, of the object O₁ determined at the O₁(x2, y0, t2) location, and at other locations along the first travel path, and based upon the distance, D1, from the O₁(x2, y0, t2) location to the collision point, CP₁₂(x0, y0).

In the second passageway 2-2, an object 3-2′ is assumed to be moving at a second velocity in the minus Y-axis direction along a second path toward the new object 3-2 location. Initially at t1 time, the object 3-2′ has coordinates x1, y0 and the object and coordinates are designated as O₂(x0, y1, t1). After moving and at a time t2, the object previously at the object 3-2′ location has moved to the object 3-2 location. At the object 3-2 location, the coordinates are x0, y2 and the object and coordinates are designated as O₂(x0, y2, t2). With such designations, the change in position from the object 3-2′ location to the object 3-2 location is measured as (y2−y1) and that change in position occurs over the time interval (t2−t1). The object O₂ continues to travel along the second travel path toward the congestion region designated as intersection 19 and hence toward the collision point, CP₁₂(x0, y0). The object O₂ will arrive at the collision point, CP₁₂(x0, y0) after traveling the distance D2 where D2 is measured by (y2−y1). The time of arrival, T₂, of the object O₂ at the collision point, CP₁₂(x0, y0), is estimated based upon the speed, S₂, of the object O₂ determined at the O₂(x0, y2, t2) location, and at other locations along the second travel path, and based upon the distance, D2, from the O₂(x0, y2, t2) location to the collision point, CP₁₂(x0, y0).

In the FIG. 1 environment, a collision between the object O₁ and the object O₂ will occur when the times T₁ and T₂ are approximately the same. A warning of the impending collision may include a safety difference value of Δt, that is, collision is predicted when T₁=(T₂+Δt) where Δt may be positive or negative.

In FIG. 1, the calculations of estimated times of arrival T₁ and T₂ of objects at a common collision point are described. While calculations based upon a single common collision point, CP₁₂(x0, y0), between moving objects is useful in some preferred embodiments, other preferred embodiments generalize the operation from a single collision point, such as CP₁₂(x0, y0), to any points in a congestion region. In FIG. 1, in one typical example, the congestion region is the intersection 19. The estimated times of arrival of two or more objects anywhere in the congestion region at about the same time or within a time window are calculated and are used to provide appropriate congestion warnings. In one simple example described, the single congestion point, CP₁₂(x0, y0), is defined as the congestion region. In other examples, the congestion region includes arrival points of objects that are spaced apart by substantial distances. For example, for pedestrians, the congestion region typically is measured as several feet. With reference to FIG. 1, in one typical example, the congestion region is the intersection 19. Accordingly calculations of estimated times of arrival T₁ and T₂ of objects are made to any points that are in or near the intersection 19. The size of the congestion region is determined as a function of the size and speed of objects moving toward the congestion region. For some congestion regions, the number of objects in or potentially in the congestion region also affects the nature of warning signals and the need for warning signals.

In some embodiments, it is assumed that there is actually or prospectively always some object in a congestion region or there is otherwise need to give warning of the arrival of a new object in the congestion region. In such embodiments, the calculation of the estimated time of arrival, T₁, of an object in the congestion region is all that is required. A warning of the arrival in some embodiments includes a safety difference value of Δt, that is, arrival is predicted when T1=Δt where Δt is positive or negative. If Δt is positive, the alarm is given Δt before the arrival in the congestion region and if Δt is negative, the alarm is given Δt after the arrival in the congestion region. If Δt is zero, the alarm is given at the estimated arrival time.

To detect the position and movement of the object O₁, the object monitor 4 includes a first sensor 5-1 that transmits a signal to the object O₁ and receives back a reflected signal from the object O₁. The transmitted and received signals 9-1 are, for example, the type of signals provided in the GE range-controlled radar motion sensor that uses a combination of controlled Doppler effect radar and passive infrared (PIR) signals or the type of signals in the Air Ultrasonic Ceramic Transducer 400ST/R160 transmitter/receiver pair where the object monitor transmits ultrasonic pulses and measures the reflected intensity and delay of echoes to determine the existence of and distance to objects. The transmitted and received signals described are merely typical examples and any other sensor technology that provides location information for moving objects may be employed.

To detect the position and movement of the object O₂, the object monitor 4 includes a second sensor 5-2 that transmits a signal to the object O₂ and receives back a reflected signal from the object O₂. The transmitted and received signals 9-2 are, for example, the same types as those described for sensor 5-1.

In the monitor 4, the sensors 5, including sensors 5-1 and 5-2, are arranged at different angles to monitor objects that move along passages 2-1 and 2-2 that intersect at 90°. The sensors 5, therefore, include a first sensor 5-1 having a first field of view and a second sensor 5-2 having a second field of view. The second field of view is oriented in a different direction from the first field of view. Each field of view extends over an aperture angle that typically ranges from 20 to 40 degrees in the XY-plane where the XY-plane is formed as the plane including the X-axis and Y-axis. The direction of the field of view is defined in one example as the center line of the field of view. Accordingly, for a 20 degree field of view in the XY-plane, the detection field is plus and minus 10 degrees from the center line. The center line and the hence the direction of the field of view of each sensor is typically adjustable in the XY-plane. Similarly, the center line is adjustable in the vertical Z-axis direction normal to the XY-plane. These adjustments in the X-axis, Y-axis and Z-axis directions typically are made by adjusting each sensor 5 so that it has the desired field of view. Typically, the desired field of view for each sensor is achieved by mechanically positioning the sensor in one or more of the X-axis, Y-axis and Z-axis directions. Mechanical positioning mechanisms are well known for making such adjustments. Alternatively, electrical and optical focusing mechanisms can also be employed for adjusting the field of view. In one embodiment, the monitor 4 includes a hinge 71 that allows sensors 5-1 and 5-2 to be rotated relative to each other and hence to be oriented in different directions. In FIG. 1, the different directions provide field-of-view angles that permit monitoring of the corridors 2-1 and 2-2 that intersect at an angle of approximately 90°. In general, the hinge 71 is of a conventional design that allows adjustment at any angle from 0 degrees to 360 degrees.

The arrangement of FIG. 1 is a typical example, and more generally, the sensors 5 may be oriented at any field-of-view angles including intersecting angles and angles in parallel. Parallel or nearly parallel field-of-view angles are employed, for example, for parallel paths such as parallel hallways that are in close proximity. Parallel hallways or other object paths frequently have merging traffic at an intersection of the paths or at a connecting path between the ends of the parallel paths.

In FIG. 1, when viewed from above, the object monitor 4 is generally L-shaped for mounting on and around the corner of two walls, for example, at the walls at the intersection 19 formed by the corridors 2-1 and 2-2. The L-shaped object monitor 4 is mounted in a location that affords a clear view of the approaches from both the X-axis and Y-axis directions along corridors 2-1 and 2-2. The installation of the object monitor 4 can be modified for different embodiments. The object monitor 4 in some embodiments is a freestanding, permanently mounted unit attached through adhesive or mechanical means to an existing wall or ceiling. Alternatively, the object monitor 4 is recessed into the wall or ceiling partially or completely. Such recessed mounting is desirable in some circumstances to decrease the likelihood that it will be broken or dislodged from its mount by passing traffic. Also, mounting can be adapted for connection to line voltage of building power for operation free from batteries (or with only standby batteries).

The object monitor 4 has two active sensors 5, including sensors 5-1 and 5-2, employed to monitor approaches from each of the corridors 2-1 and 2-2. An intelligent processor 6, for example made of dedicated hardware or a microcomputer, compares signals from the two sensors 5-1 and 5-2. Each sensor 5 detects traffic approaching the monitored intersection 19 to calculate the possibility of a potential collision. The object monitor 4 can be building-powered with line voltage or battery-powered. In some embodiments, the frequency of active detection is typically increased when a collision is increasingly likely and is decreased when a collision is unlikely. If battery-powered, such increasing and decreasing operation reduces energy consumption when collisions are not very likely. If the objects are approaching each other on a potential collision course, the object monitor 4 initiates an audible and/or visible alarm. If the potential collision condition continues, the nature of the alarm becomes more imperative, for example, by increasing volume, pitch, and/or increasing the rate of flashing. As the potential for collision decreases, the object monitor 4 ramps down the warnings and stops the warnings once the potential for collision is past.

Various refinements in operation can be adopted to further increase the utility of the object monitor 4. For example, the object monitor 4 includes in some embodiments controlling logic that determines a “short notice” condition, which appears suddenly when significant risk of collision is present, so as to provide an immediate, imperative and attention-grabbing warning. Another refinement is programmability for different applications. For example, in a hospital it often is desirable to make a more noticeable warning in areas where the ambient noise is high or to provide a sooner warning in areas where pedestrians are moving more quickly. Also, the object monitor 4, in some embodiments, is equipped with a sensor to determine ambient noise and to provide a more noticeable warning when ambient noise is higher.

Another refinement establishes the monitor 4 with differing priorities for each approach direction. For example, the object coming from the direction with lower priority is warned before the object coming from the higher priority direction. In this manner, if traffic on the lower priority path is altered in response to the warning given to the objects on the lower priority path, traffic on the higher priority path need not be warned or adjusted, or need be warned or adjusted less frequently, thereby affording smoother flow of traffic.

The logic of the object monitor 4 in some embodiments records warning situations that occur over time. For example, the shortest distances at which detection occurs in each monitored direction are recorded. If the object monitor 4 determines that one or more directions typically has a sudden appearance of an object, such as someone stepping out of a doorway and turning towards the object monitor 4, the object monitor 4 modifies its operation to respond earlier and/or more firmly. The object monitor 4, in some embodiments is deployed at elevator doors and the logic in the object monitor 4 “understands” the role of the elevator door as well as the shape, appearance and/or sonic signature of an unoccupied elevator.

The object monitor 4 is not limited to being a 90 degree, L-shaped design or to having only two sensors 5. In general, the object monitor 4 includes any number of one or more sensors 5 directed in one or more different directions. The object monitor 4 is embodied as a central monitor with any number of local sensors 5. Alternatively, monitor is associated with any number of remote sensors 5. The determination of which sensors 5 interact with other sensors 5 is under control of the processor 6.

FIG. 2 depicts a block diagram representation of one embodiment of the object monitor 4 of FIG. 1. The object monitor 4 includes a first sensor 5-1 that transmits and receives signals 9-1 where the transmitted signal is to an object and the received signal is reflected back from the object as described in connection with FIG. 1. The object monitor 4 includes a second sensor 5-2 that transmits and receives signals 9-2 where the transmitted signal is to an object and the received signal is reflected back from the object as described in connection with FIG. 1. The transmitted and received signals 9-1 and 9-2 are, for example, the type of signals provided in the GE range-controlled radar motion sensor that uses a combination of controlled Doppler effect radar and passive infrared (PIR) signals or the type of signals in the Air Ultrasonic Ceramic Transducer 400ST/R160 transmitter/receiver pair where the object monitor transmits ultrasonic pulses and measures the reflected intensity and delay of echoes to determine the existence of and distance to objects, but can alternatively be any other signals that provide position information.

In FIG. 2, the object monitor 4 includes the processor 6 which, in one embodiment, is the processor provided in the GE range-controlled radar motion sensor. In alternative embodiments, the processor 6 is a conventional microprocessor that executes routines for determining the position, velocity and estimated collision times of objects detected by the sensors 5-1 and 5-2. The processor 6 includes or is associated with memory 61 for storing routines and other information useful in performing the algorithms used for collision predictions of moving objects. The memory 61 typically includes EEPROM or similar non-volatile memory for storing data.

In FIG. 2, the object monitor 4 includes input/output device 7. The input/output device 7 provides manual or automated mechanisms for loading routines and setup information into the processor 6. Also, the input/output device 7 receives collision prediction and other signals from the processor 6 which are used by the input/output device 7 to sound visual, audible and other alarms warning of a predicted collision and to provide other output information.

A typical operation of the object monitor 4 for predicting a collision of the objects O₁ and O₂ of FIG. 1 is described in connection with the steps in TABLE 1 as follows:

TABLE 1

| | |
|---|---|
| 1 | For object O₁ |
| 2 | At t1, determine distance, d₁, to first position, P₁O₁, (x1,y0) |
| 3 | At t2, determine distance, d₂, to second position, P₂O₁, (x2,y0) |
| 4 | Calculate change in position, δd, from P₁O₁ to P₂O₁, δd = δ(d₂− d₁) = (x2−x1) |
| 5 | Calculate change in time, δt, from P₁O₁, P₂O₁, δt = (t2−t1) |
| 6 | Calculate speed S₁ = (δd/δt) |
| 7 | Calculate distance, D1, of O₁ from collision point, D1 = (x2 −x0) |
| 8 | Calculate estimated time of arrival, T_{1,} of O₁ at collision point, T₁ = (D1)(S₁) |
| 9 | |
| 10 | For object O₁ |
| 11 | At t1, determine distance, d₁, to first position, P₁O₂, (x0,y1) |
| 12 | At t2, determine distance, d₂, to second position, P₂O₂, (x0,y2) |
| 13 | Calculate change in position, δd, from P₁O₂ to P₂O₂, δd = δ(d₂− d₁) = (y2−y1) |
| 14 | Calculate change in time, δt, from P₁O₂ to P₂O₂, δt = (t2−t1) |
| 15 | Calculate speed S₂ (δd/δt) |
| 16 | Calculate distance, D2, of O₂ from collision point, D2 = (y2 −y0) |
| 17 | Calculate estimated time of arrival, T_{1,} of O₂ at collision point, T₂ = (D2)(S₂) |
| 18 | |
| 19 | Calculate difference, δT, in estimated time of arrival of O₁ and O₂ at collision point, |
| | δT = (T₂ − T₁) |
| 20 | If (T₂ − T₁) ≦ K, |
| 21 | Send Collision Alarm Signal, |
| 22 | ELSE, End Collision Alarm Signal |
| 23 | Repeat |

In FIG. 1, the sensor 5-1 is oriented to measure distance in the X-axis direction. At time t1, the object 3-1′ (O₁) is located a distance d₁ from the sensor 5-1. At time t2, the object 3-1′ has moved in the −X-axis direction to 3-1 so that O₁ is located a distance d₂ from the sensor 5-1. Also, in FIG. 1, the sensor 5-2 is oriented to measure distance in the Y-axis direction. At time t1, the object 3-2′ (O₂) is located a distance d₁ from the sensor 5-2. At time t2, the object 3-2′ has moved in the −Y-axis direction to 3-2 so that O₂ is located a distance d₂ from the sensor 5-2. The sensors 5-1 and 5-2 detect the distances d₁ and d₂ at t1 and t2 for each of O₁ and O₂. With these measured values, the processor 6 of FIG. 2 calculates the values of TABLE 1.

In processor 6 for O₁, the change in position, δd, from P₁O₁, O₁(x1, y0, t1), to P₂O₁, O₁(x2, y0, t2), is calculated as δd=δ(d₂−d₁)=(x2−x1). The change in time, δt, for object O₁ moving from P₁O₁ to P₂O₁ is calculated as δt=(t2−t1). The speed, S₁, of O₁ is calculated as S₁=(δd/δt). The distance, D1, of O₁ from the collision point CP₁₂(x0, y0) is calculated as D1=(x2−x0). The estimated time of arrival, T₁, of O₁ at the collision point CP₁₂(x0, y0) is calculated as T₁=(D1)/(S₁).

In processor 6 for O₂, the change in position, δd, from P₁O₂ to P₂O₂ is calculated as δd=δ(d₂−d₁)=(y2−y1). The change in time, δt, for object O₂ moving from P₁O₂ to P₂O₂ is calculated as δt=(t2−t1). The speed, S₂, of O₂ is calculated as S₂=(δd/δt). The distance, D2, of O₂ from the collision point CP₁₂(x0, y0) is calculated as D2=(y2−y0). The estimated time of arrival, T₂, of O₂ at collision point is calculated as T₂=(D2)/(S₂).

With these calculations, the processor 6 of FIG. 2 calculates the difference, δT, in estimated time of arrival of O₁ and O₂ at collision point CP₁₂(x0, y0) as δT=(T₂−T₁). If δT≦K, then a Collision Alarm Signal is sent to the I/O device 4 of FIG. 2. The value of K is selected to give adequate warning for a potential collision. For example, if the objects are pedestrians traveling at a slow pace, then K might be selected when T₂ or T₁ are about 15 or more seconds. The higher the speed of an object, the greater the value of K required and hence the greater the warning time provided. If δT>K, then any pending Collision Alarm Signal to the I/O device 4 is terminated. The processing of TABLE 1 continuously repeats.

A software code representation of the object monitor 4 operations appears in TABLE 2 as follows:

TABLE 2

| | // | | |
|---|---|---|---|
| | // | | |
| 1 | #define SENSORS | 3 | // for typical two-way |
| | corner; 3 for T-type | | |
| 2 | #define FACTOR | 6802.721 | // for 147us / inch |

| | | | |
|---|---|---|---|
| 3 | #define MIN_PULSE_LENGTH | 5 | // design choice, may be other |
| | value | | |
| 4 | #define MAXIMUM_LEDS | 6 | // design choice, may be other |
| | value | | |
| 5 | #define MULTIPLE_OUTPUTS | true | // allows prioritized warnings |
| 6 | | | |

| 7 | // | |
|---|---|---|
| 8 | // This routine is customized for each CPU | |
| 9 | // | |
| 10 | | |
| 11 | double getTimeInSeconds( ) | |
| 12 | { | |
| 13 | double seconds = 0.0; | |
| 14 | // read system clock and convert its units to the seconds variable | |
| 15 | return seconds; | |
| 16 | } | |
| 17 | | |
| 18 | // | |
| 19 | // Hardware control of LEDs | |
| 20 | // | |
| 21 | | |
| 22 | void turnOnLEDs(int leds, int latch) | |
| 23 | { | |
| 24 | unsigned char mask = 0; | |
| 25 | for (int i=0; i<leds; i++) | |
| 26 | mask \|= (1 << i); | |
| 27 | // write mask to selected hardware latch; | |
| 28 | } | |
| 29 | | |
| 30 | // | |
| 31 | // Configuration data that may be stored in EEPROM or similar non-volatile memory | |
| 32 | // | |
| 33 | | |
| 34 | class Config | // Configuration variables |
| | that may be adjusted | |
| 35 | { | // by the user or |
| | by analyzing past operation | |
| 36 | public: | |
| 37 | double minSafeTime; | // minimum safe time in seconds, |
| | default 3 | |
| 38 | double congestionSize; | // size of congestion region in |
| | seconds, default 1 | |
| 39 | bool usePulseWidth; | // use pulse width for determining |
| | valid reflection | |

| 40 | double warningPriority[SENSORS]; // 0.0 -> 1.0, where 0.0 is highest priority | |
|---|---|---|
| 41 | char alwaysActive[SENSORS]; | // true if treated as if someone was always |
| | present | |
| 42 | }; | |
| 43 | | |
| 44 | Config config = { 3.0, 1.0, true }; | / / remaining values default to zero |
| 45 | | |
| 46 | // | |

| 47 | // Information associated with each sensor | |
|---|---|---|
| 48 | // | |
| 49 | | |
| 50 | int sensorLatch[SENSORS] = { 0, 1, 2 }; | // values as appropriate to |
| | hardware | |
| 51 | int hardwareMuxData[SENSORS] = { 0, 1, 2 }; | // values as appropriate to |
| | hardware | |
| 52 | | |

| | |
|---|---|
| 53 | class Sensor |
| 54 | { |
| 55 | public: |
| 56 | // |
| 57 | // Device-dependent routines |
| 58 | // |
| 59 | void setHardwareMux( ) |
| 60 | { |
| 61 | // write hardwareMuxData[deviceNumber] to hardware latch as required |
| 62 | } |
| 63 | void setPulseFound(int cycles) |
| 64 | { |
| 65 | if (cycles >= MIN_PULSE_LENGTH) |
| 66 | cycleCountDetected \|= (1 << (cycles − MIN_PULSE_LENGTH)); |
| 67 | }; |
| 68 | bool isCycleCountUsed(int cycles) |
| 69 | { |
| 70 | if (cycles < MIN_PULSE_LENGTH) |
| 71 | return true; |
| 72 | return (cycleCountDetected & (1 << (cycles − MIN_PULSE_LENGTH))) ? |
| | true : false; |
| 73 | }; |
| 74 | void emitPulse( ) |
| 75 | { |
| 76 | for (int pulse=0; pulse<cycleCount; pulse++) |
| 77 | { |
| 78 | // toggle hardware bit high |
| 79 | // delay half of ~40kHz duty cycle |
| 80 | // toggle hardware bit low |
| 81 | // delay half of ~40kHz duty cycle |
| 82 | } |
| 83 | } |
| 84 | void emitSensorWarning(double warningLevel) |
| 85 | { |
| 86 | turnOnLEDs((int) (warningLevel * MAXIMUM_LEDS), sensor- |
| | Latch[deviceNumber]); |
| 87 | |

| | |
|---|---|
| 88 | // could also adjust volume/nature of general |

or

| | |
|---|---|
| 89 | // sensor-specific audible signal based on |

| | warningLevel | |
|---|---|---|
| 90 | } | |
| 91 | int isRecieveBitActive( ) | |
| 92 | { | |
| 93 | // if hardware bit from receiver is active, return true, otherwise | |
| 94 | return false; | |
| 95 | } | |
| 96 | int checkReceiverForSignal(double maxSeconds) | |
| 97 | { | |
| 98 | double startTime = getTimeInSeconds( ); | |
| 99 | int signalRcvd = false; | |
| 100 | while ((getTimeInSeconds( ) − startTime) < maxSeconds && !signalRcvd) | |
| 101 | signalRcvd = isRecieveBitActive( ); | |
| 102 | if (!signalRcvd) | // nothing received at all |

| 103 | return 0; | |
|---|---|---|
| 104 | int cycleCount = 0; | |
| 105 | // detect series of highs and lows using isReceiveBitActive( ), | |
| 106 | // incrementing cycleCount for each new high that is received | |
| 107 | // within the maxSeconds timeout period | |
| 108 | return cycleCount; | |
| 109 | } | |
| 110 | | |
| 111 | // | |
| 112 | // Volatile variables | |
| 113 | // | |
| 114 | | |
| 115 | double distance; | // distance after most recent ping |
| 116 | double velocity; | // in meters/sec, defaults to 1.0 |
| 117 | double lasttime; | // time of last ping in seconds |
| 118 | bool otherSignalDetected; | // true if sensor detects signal from other unit |
| 119 | unsigned long cycleCountDetected; | // bit flags for pulse counts of 5-36 |
| 120 | unsigned long deviceNumber; | // zero-based |
| 121 | unsigned char cycleCount; | // number of cycles to emit in burst |
| 122 | }; | |
| 123 | | |
| 124 | // | |
| 125 | // Structure to pair sensors that can interact | |
| 126 | // | |
| 127 | | |
| 128 | class Interaction | |
| 129 | { | |
| 130 | public: | |
| 131 | int sensor1; | // first sensor in pair |
| 132 | int sensor2; | // second sensor in pair |

| | |
|---|---|
| 133 | }; |
| 134 | |
| 135 | // |
| 136 | // Global variables |
| 137 | // |
| 138 | |
| 139 | #define INTERACTIONS 2 |
| 140 | |
| 141 | Interaction interaction[INTERACTIONS] = { 0, 1, |

| | |
|---|---|
| 142 | 0, 2 }; |
| 143 | |

| 144 | Sensor sensor[SENSORS]; | |
|---|---|---|
| 145 | | |
| 146 | /////////////////////////////////////////////////////////////////////////////////// | |
| 147 | // | |
| 148 | // Primary code | |
| 149 | | |
| 150 | // | |
| 151 | // Determine if two sensors should interact with each other | |
| 152 | // | |
| 153 | | |
| 154 | bool interactionAllowed(int s1, int s2) | |
| 155 | { | |
| 156 | for (int i=0; i<INTERACTIONS; i++) | |
| 157 | if (interaction[i].sensor1 == s1 && interaction[i].sensor2 == s2 \|\| | |
| 158 | interaction[i].sensor1 == s2 && interaction[i].sensor2 == s1) | |
| 159 | return true; | |
| 160 | return false; | |
| 161 | } | |
| 162 | | |
| 163 | // | |
| 164 | // Get data from sensor, avoiding confusion with other sources | |
| 165 | // | |
| 166 | | |
| 167 | void getSensorInformation(Sensor *s) | |
| 168 | { | |
| 169 | s->setHardwareMux( ); | // |

| | select sensor in use | |
|---|---|---|
| 170 | | |
| 171 | if (config.usePulseWidth) | |
| 172 | { | |
| 173 | if (!s->cycleCount) | |
| 174 | { | |
| 175 | for (s->cycleCount = MIN_PULSE_LENGTH; | |
| 176 | s->cycleCount < MIN_PULSE_LENGTH + 33; | |
| 177 | s->cycleCount++) | |
| 178 | { | |
| 179 | if (!s->isCycleCountUsed(s->cycleCount)) | |
| 180 | break; | |
| 181 | } | |
| 182 | } | |
| 183 | if (s->cycleCount >= MIN_PULSE_LENGTH + 33) | |
| 184 | { | |
| 185 | s->distance = s->velocity = s->lasttime = 0.0; | |
| 186 | return; | |
| 187 | } | |
| 188 | } | |
| 189 | else if (s->otherSignalDetected) | |
| 190 | s->checkReceiverForSignal(0.15); | |
| 191 | | |
| 192 | double startTime = getTimeInSeconds( ); | |
| 193 | s->emitPulse( ); | |
| 194 | | |
| 195 | int cycleCount = s->checkReceiverForSignal(0.05); | |
| 196 | if (cycleCount != 0) | |
| 197 | { | |
| 198 | if (config.usePulseWidth) | // look for proper cycle count |

| 199 | { | |
|---|---|---|
| 200 | if (cycleCount != s->cycleCount) | |
| 201 | { | |
| 202 | cycleCount = s->checkReceiverForSignal(0.05); | |
| 203 | if (cycleCount != s->cycleCount) | |
| 204 | { | |
| 205 | cycleCount = s->checkReceiverForSignal(0.05); | |
| 206 | if (cycleCount != s->cycleCount) | |
| 207 | { | |
| 208 | s->distance = s->velocity = s->lasttime = 0.0; | |
| 209 | return; | |
| 210 | } | |
| 211 | } | |
| 212 | } | |
| 213 | } | |
| 214 | | |
| 215 | double seconds = getTimeInSeconds( ); | |
| 216 | double inches = seconds * FACTOR; // scales time to distance, inches | |
| 217 | if (s->lasttime == 0.0) | |
| 218 | s->velocity = 36.0; // use default value of 36 inches/sec | |
| 219 | Else | |
| 220 | { | |
| 221 | double deltaT = s->lasttime − seconds; | |
| 222 | s->lasttime = seconds; | |
| 223 | if (deltaT > 0.0) | |
| 224 | s->velocity = (s->distance − inches) / deltaT; | |
| 225 | s->distance = inches; | |
| 226 | } | |
| 227 | } | |
| 228 | Else | |
| 229 | s->distance = s->velocity = s->lasttime = 0.0; | |
| 230 | } | |
| 231 | | |
| 232 | // | |
| 233 | // Determine if a sensor needs a time slot, and find used | |
| 234 | // pulse widths if in usePulseWidth mode. | |
| 235 | // | |
| 236 | | |
| 237 | void determineTimeSlot(Sensor *s) | |
| 238 | { | |
| 239 | s->setHardwareMux( ); | // |

| | select sensor in use | |
|---|---|---|
| 240 | | |
| 241 | double startTime = getTimeInSeconds( ); | |
| 242 | int cycleCount = 1; | |
| 243 | while (cycleCount) | |
| 244 | { | |
| 245 | cycleCount = s->checkReceiverForSignal(0.5); | |
| 246 | if (cycleCount) | |
| 247 | { | |
| 248 | if (config.usePulseWidth) | |
| 249 | { | |
| 250 | if (!s->isCycleCountUsed(cycleCount)) | // already detected |
| 251 | s->setPulseFound(cycleCount); | // flag it as used |

| 252 | } | |
|---|---|---|
| 253 | else | |
| 254 | { | |
| 255 | s->otherSignalDetected = true; | // |

| | flag need to wait | |
|---|---|---|
| 256 | break; | |
| | // and stop scanning | |
| 257 | } | |
| 258 | } | |
| 259 | } | |
| 260 | } | |
| 261 | | |
| 262 | // | |
| 263 | // Return probability of collision as a value between 0.0 and 1.0 inclusive | |
| 264 | // | |
| 265 | | |
| 266 | double probabilityOfCollision(Sensor *s1, Sensor *s2) | |
| 267 | { | |
| 268 | if (s1->velocity <= 0.0 \|\| s2->velocity <= 0.0) | |
| 269 | return 0.0; | |
| 270 | if (config.alwaysActive[s1->deviceNumber] && config.alwaysActive[s1- | |
| | >deviceNumber]) | |
| 271 | return 0.0; // two always-active sensors should not interact | |
| 272 | | |
| 273 | double seconds1 = s1->distance / s1->velocity; | |
| 274 | double seconds2 = s2->distance / s2->velocity; | |
| 275 | double delta = seconds2 − seconds1; | // difference in arrival times |
| 276 | | |
| 277 | if (config.alwaysActive[s1->deviceNumber]) | |
| 278 | delta = seconds1; | |
| 279 | else if (config.alwaysActive[s2->deviceNumber]) | |
| 280 | delta = seconds2; | |
| 281 | | |
| 282 | if (delta < 0.0) | // ensure time is positive |
| 283 | delta *= −1.0; | |
| 284 | double minTime = config.minSafeTime + config.congestionSize; | |
| 285 | if (delta >= minTime) | |
| 286 | return 0.0; | |
| 287 | double risk = (minTime − delta) / minTime; | |
| 288 | double minSecs = (seconds1 < seconds2) ? seconds1 : seconds2; | |
| 289 | if (minSecs < 1.0) | |
| 290 | minSecs = 1.0; | // protect from erratic values |
| 291 | return risk / minSecs; | |
| 292 | } | |
| 293 | | |
| 294 | // | |
| 295 | // Depending on warning device type, emit sound or light indicator based on warningLevel | |
| 296 | // if warningLevel < threshold, disable all warning devices | |
| 297 | // | |
| 298 | | |
| 299 | void emitGeneralWarning(double warningLevel) | |
| 300 | { | |
| 301 | turnOnLEDs((int) (warningLevel * MAXIMUM_LEDS), hardwareMuxData[0]); | |
| 302 | | |
| 303 | // could also adjust volume/nature of audible signal based on warningLevel | |
| 304 | } | |
| 305 | | |
| 306 | // | |
| 307 | // Initialization | |
| 308 | // | |
| 309 | | |
| 310 | void init( ) | |
| 311 | { | |
| 312 | for (int i=0; i<SENSORS; i++) | |
| 313 | { | |
| 314 | sensor[i].distance = sensor[i].velocity = sensor[i].lasttime = 0.0; | |
| 315 | sensor[i].otherSignalDetected = false; | |
| 316 | sensor[i].cycleCountDetected = 0; | // clear all bit flags |
| 317 | sensor[i].deviceNumber = i; | |
| 318 | sensor[i].cycleCount = 0; | // will be assigned before using |
| 319 | } | |

| | | |
|---|---|---|
| 320 | for (i=0; i<SENSORS; i++) | // do all sensors when using pulse width |

| 321 | determineTimeSlot(&sensor[i]); | |
|---|---|---|
| 322 | } | |
| 323 | | |
| 324 | // | |
| 325 | // Main loop - monitor all sensors that interact | |
| 326 | // and warn if the potential for a collision exists | |
| 327 | // | |
| 328 | | |
| 329 | void main( ) | |
| 330 | { | |
| 331 | // read EEPROM or other storage and load config structure | |
| 332 | // initialize hardware on CPU as required by the device | |
| 333 | | |
| 334 | init( ); // initialize data | |
| 335 | | |
| 336 | while (true) | |
| 337 | { | |
| 338 | for (int i=0; i<SENSORS; i++) // do all sensors when using pulse width | |
| 339 | getSensorInformation(&sensor[i]); | |
| 340 | | |
| 341 | double warningLevel = 0.0; | |
| 342 | for (int s1=0; s1<SENSORS−2; s1++) | |
| 343 | { | |
| 344 | for (int s2=s1+1; s2<SENSORS−1; s2++) | |
| 345 | { | |
| 346 | if (interactionAllowed(s1, s2)) | // |

| | based on config table | |
|---|---|---|
| 347 | { | |
| 348 | double prob = probabilityOfCollision(&sensor[s1], | |
| | &sensor[s2]); | |
| 349 | if (prob > warningLevel) | |
| 350 | warningLevel = prob; | |
| 351 | if (MULTIPLE_OUTPUTS) | // some |

| | |
|---|---|
| | sensors are less reactive |
| 352 | { |
| 353 | double prob1 = prob − config |
| | .warningPriority[s1]; |
| 354 | if (prob1 < 0.0) |
| 355 | prob1 = 0.0; |

| | |
|---|---|
| 356 | sensor[s1].emitSensorWarning(prob1); |

// if zero, turns off warning

| | |
|---|---|
| 357 | double prob2 = prob − |

config.warningPriority[s2];

| | |
|---|---|
| 358 | if (prob2 < 0.0) |
| 359 | prob2 = 0.0; |
| 360 | sensor[s2].emitSensorWarning(prob2); |

// if zero, turns off warning

| | |
|---|---|
| 361 | } |
| 362 | } |
| 363 | } |
| 364 | } |
| 365 | if (!MULTIPLE_OUTPUTS) |
| 366 | emitGeneralWarning(warningLevel); |

// if zero, turns off warning

| | |
|---|---|
| 367 | } |
| 368 | } |

TABLE 2 is a code representation for use with a conventional microprocessor and can be used for example with an ultrasonic object monitor of the type described above under the background.

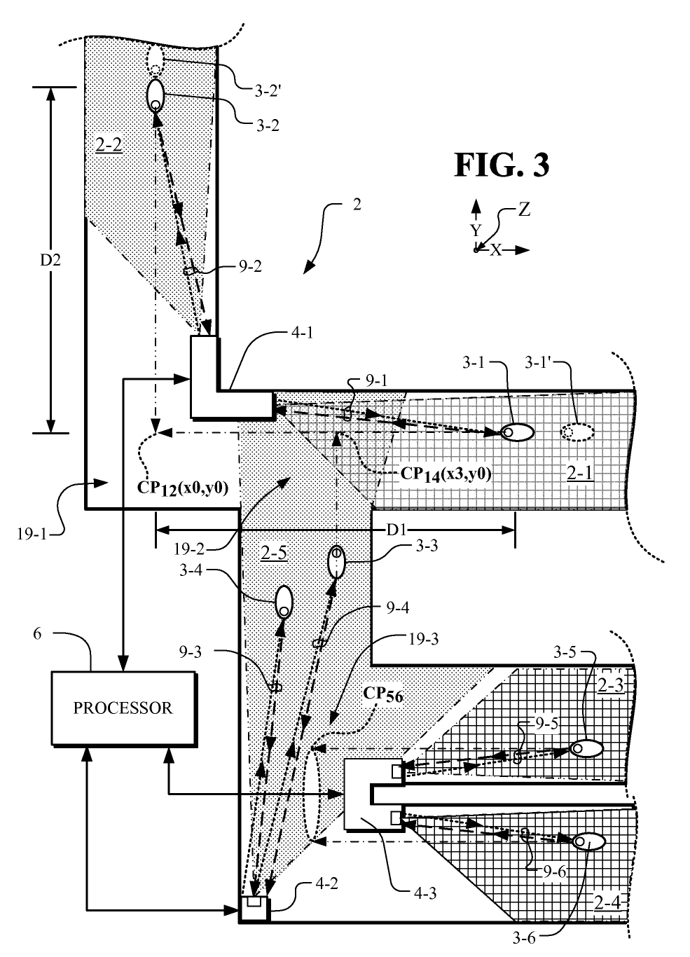

FIG. 3 depicts a plurality of object monitors 4-1, 4-2 and 4-3 located in an environment where a plurality of potential collisions exists. The pathway 2 includes the passageways 2-1, 2-2, 2-3, 2-4, and 2-5. The passageways have the moving objects 3-1, 3-2, 3-3, 3-4, 3-5 and 3-6. The objects 3-1 and 3-2 are in the passageways 2-1 and 2-2, respectively, analogous to the environment shown in FIG. 1. The objects 3-3 and 3-4 are in passageway 2-5 and are moving in opposite Y-axis directions. The objects 3-5 and 3-6 are in passageways 2-3 and 2-4, respectively, and are moving in the minus X-axis direction.

In FIG. 3, like in FIG. 1, it is assumed that the objects 3-1′ and 3-2′ are moving toward the blind intersection 19-1 and hence are in an environment where a collision can occur.

In FIG. 3, in the first passageway 2-1, the object 3-1′ is assumed to be moving at a first velocity in the minus X-axis direction along a first path toward the intersection 19-1 and hence toward the collision point, CP₁₂(x0, y0). The object O₁ will arrive at the collision point, CP₁₂(x0, y0) after traveling the distance D1. The time of arrival, T₁, of the object O₁ at the collision point, CP₁₂(x0, y0), is estimated based upon the speed, S₁, of the object O₁ determined at locations along the first travel path in passageway 2-1, and based upon the distance remaining to the collision point, CP₁₂(x0, y0).

In FIG. 3, in the second passageway 2-2, an object 3-2′ is assumed to be moving at a second velocity in the minus Y-axis direction along a second path toward the intersection 19-1 and hence toward the collision point, CP₁₂(x0, y0). The object O₂ will arrive at the collision point, CP₁₂(x0, y0), after traveling the distance D2. The time of arrival, T₂, of the object O₂ at the collision point, CP₁₂(x0, y0), is estimated based upon the speed, S₂, of the object O₂ determined at locations along the second travel path in passageway 2-2, and based upon the distance, D2, remaining to the collision point, CP(x0, y0).

In the FIG. 3 environment, a collision between the object O₁ and the object O₂ is predicted to occur when the times T₁ and T₂ are approximately the same. A warning of the impending collision may include a safety difference value of Δt, that is, collision is predicted when T₁=(T₂+Δt) where Δt may be positive or negative.

In the FIG. 3, to detect the position and movement of the object O₁, the object monitor 4-1 as described in connection with FIG. 1, includes a first sensor that transmits a signal to the object O₁ and receives back a reflected signal from the object O₁. The transmitted and received signals 9-1 are, for example, the type of signals provided in the GE range-controlled radar motion sensor or the type of signals in the Air Ultrasonic Ceramic Transducer 400ST/R160 transmitter/receiver pair

In the FIG. 3, to detect the position and movement of the object O₂, the object monitor 4-1 includes a second sensor that transmits a signal to the object O₂ and receives back a reflected signal from the object O₂. The transmitted and received signals 9-2 are, for example, the type of signals provided in the GE range-controlled radar motion sensor or the type of signals in the Air Ultrasonic Ceramic Transducer 400ST/R160 transmitter/receiver pair.

In the FIG. 3, the monitor 4-1, is like the monitor 4 in FIG. 1 and has sensors arranged at an angle to monitor objects that move along passages 2-1 and 2-2 that intersect at 90° at the collision point, CP(x0, y0).

A typical operation of the object monitor 4-1 for predicting a collision of the objects O₁ and O₂ of FIG. 3 is described in connection with the software routines in TABLE 1 above.

In FIG. 3, in the first passageway 2-1, the object 3-1′ is again assumed to be moving at a first velocity in the minus X-axis direction along a first path toward the intersection 19-2 of passageway 2-1 and 2-5 and hence toward the collision point, CP₁₄(x3, y0). The object O₁ will arrive at the collision point, CP₁₄(x3, y0) after traveling the distance measured by (x2−x3). The time of arrival, T₃, of the object O₁ at the collision point, CP₁₄(x3, y0), is estimated based upon the speed, S₁, of the object O₁ determined at locations along the travel path in passageway 2-1, and based upon the distance remaining to the collision point, CP₁₄(x3, y0).

In FIG. 3, to detect the position and movement of the object O₁, the object monitor 4-1 transmits a signal to the object O₁ and receives back a reflected signal from the object O₁. The transmitted and received signals 9-1 are, for example, the type of signals provided in the GE range-controlled radar motion sensor or the type of signals in the Air Ultrasonic Ceramic Transducer 400ST/R160 transmitter/receiver pair.

In FIG. 3, in another second passageway 2-5, object 3-4 (designated as O₃) is assumed to be moving at a second velocity in the positive Y-axis direction along a second path from a location (x3, y4) toward the intersection 19-2 and hence toward the collision point, CP₁₄(x3, y0). The object O₃ will arrive at the collision point, CP₁₄(x3, y0), after traveling a distance measured by (y4−y0). The time of arrival, T₄, of the object O₃ at the collision point, CP₁₄(x3, y0), is estimated based upon the speed, S₃, of the object O₃ determined at locations along the second travel path in passageway 2-5, and based upon the distance remaining to the collision point, CP₁₄(x3, y0).

In FIG. 3, to detect the position and movement of the object O₃, the object monitor 4-2 transmits a signal to the object O₃ and receives back a reflected signal from the object O₃. The transmitted and received signals 9-4 are, for example, the type of signals provided in the GE range-controlled radar motion sensor or the type of signals in the Air Ultrasonic Ceramic Transducer 400ST/R160 transmitter/receiver pair. The object monitor 4-2 in the embodiment shown only employs a single sensor. While the monitor 4-1 includes two sensors as previously described, only one of the two sensors of monitor 4-1 is employed in the present example.

In the FIG. 3 environment, a collision between the object O₁ and the object O₃ will occur when the times T₃ and T₄ are approximately the same. A warning of the impending collision may include a safety difference value of Δt, that is, collision is predicted when T₃=(T₄+Δt) where Δt may be positive or negative. In one embodiment, the monitors 4-1 and 4-2 connect to a processor 6 to make the calculations including the T₃=(T₄+Δt) calculation for predicting a collision.

In FIG. 3, the passageways 3-5 and 3-6 are parallel and are closely located. In a first passageway 2-3, the object 3-5 (designated as O₅) is assumed to be moving at a first velocity in the minus X-axis direction along a first path toward the intersection region 19-3 and hence toward a collision point (region), CP₅₆, somewhere in the intersection region 19-3. The object O₅ will arrive at the collision point (region), CP₅₆, after traveling from its initial location to the collision point, CP₅₆. The time of arrival, T₅, of the object O₅ at the collision point, CP₅₆, is estimated based upon the speed, S₅, of the object O₅ determined at locations along the first travel path in passageway 2-3, and based upon the distance remaining to the collision point, CP₅₆.

In a second passageway 2-4, the object 3-6 (designated as O₆) is assumed to be moving at a first velocity in the minus X-axis direction along a second path toward the intersection region 19-3 and hence toward a collision point (region), CP₅₆, somewhere in the intersection region 19-3. The object O₆ will arrive at the collision point, CP₅₆, after traveling from its initial location to the collision point (region), CP₅₆. The time of arrival, T₆, of the object O₆ at the collision point, CP₅₆, is estimated based upon the speed, S₆, of the object O₆ determined at locations along the second travel path in passageway 2-4, and based upon the distance remaining to the collision point, CP₅₆.

In the FIG. 3, the monitor 4-3 has two sensors arranged at an angle of approximately 180° (that is, in parallel) to monitor objects that move along parallel passages 2-3 and 2-4. The movement of the objects 3-5 and 3-6 along parallel passages 2-3 and 2-4 are not limited to straight-lines and any movement in the intersection region 19-3 may result in a collision.

While several travel patterns of the objects 3-1, 3-2, 3-3, 3-4, 3-5 and 3-6 of FIG. 3 have been described, other patterns are possible that can lead to potential collisions. For example, object 3-4 (designated as O₄) in pathway 2-5 travels in the minus Y-axis direction and hence might have a collision point, C₄₅, (not shown) with the O₅ object or might have a collision point, C₄₆, (not shown) with the O₆ object. Also, by way of further example, object O₂ in pathway 2-2 travels in the minus Y-axis direction toward the region 19-1 and thereafter may turn and continue in the plus X-axis direction pathway toward the region 19-2. Hence, object O₂ might have a potential collision point, C₂₃, (not shown) with the O₃ object, might have a potential collision point, C₂₅, (not shown) with the O₅ object or might have a potential collision point, C₂₆, (not shown) with the O₆ object. These and other potential collisions might occur in the FIG. 3 environment. In general, the regions 19-1, 19-2 and 19-3 are congestion regions. While typical calculations have been described with respect to a single collision point common for two or more objects, the calculations in other embodiments are made for different arrival points anywhere within the collection regions.

Typical operations of the object monitors 4-1, 4-2 and 4-3 for predicting collisions of the objects O₁, O₂, O₃, O₄, O₅, and O₆ of FIG. 3 are described in connection with the software routines in TABLE 3 as follows:

TABLE 3

| | |
|---|---|
| 1 | For each object O₁, O₂, ..., Oᵢ, ..., Oₙ, |
| 2 | At t1, determine position (x, y)₁ |
| 3 | At t2, determine position (x, y)₂ |
| 4 | Determine δxy = (Δxy) |
| 5 | Determine δt = (Δt) |
| 8 | Determine speed Sᵢ = (δxy/δt) |
| 9 | Determine Dᵢ = Δ(xy₂−xy₁) |
| 10 | Determine Tᵢ = (Dᵢ)/(Sᵢ) |
| 11 | |
| 12 | For each object arrival time T₁, T₂, ..., Tᵢ, ..., Tₙ, |
| 13 | Calculate (T₍ᵢ₊₁₎ − T₍ᵢ₎) |
| 14 | If (T₍ᵢ₊₁₎ − T₍ᵢ₎) ≦ K, |
| 15 | Send Collision Alarm Signal, |
| 16 | ELSE, repeat lines 1-16 |

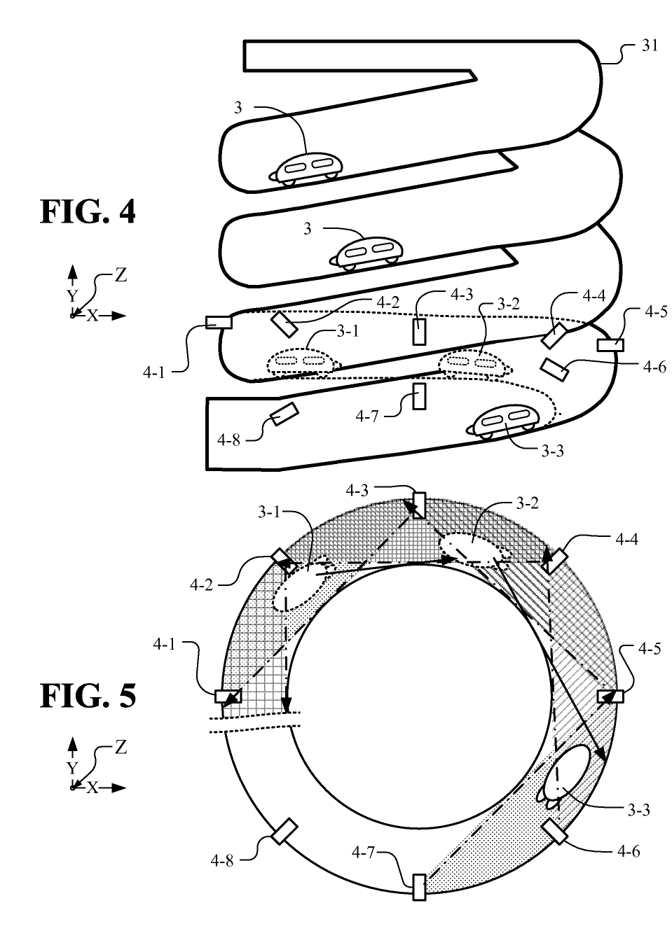

FIG. 4 depicts a plurality of object monitors 4, including monitors 4-1, 4-2, . . . , 4-8, located in a spiral ramp 31 typical of automobile parking structures. In such parking structures, spiral, helix-shaped or other-wise curved ramps allow cars to drive from floor to floor in a contained area. In one embodiment, two-way traffic presents an environment where vehicles can cross the center line and in some such embodiments, the monitors 4 are positioned to warn of such crossovers. In another embodiment as shown in FIG. 4, the ramp 31 has one-way traffic so that the potential for collisions is present for cars traveling in the same direction. Since line-of-sight visibility is limited by the curve of the ramp 31, cars proceeding from behind quickly come upon slower traveling forward cars with little or no visible warning. The object monitors 4 monitor the speeds and locations of cars as they follow each other through the spiral of ramp 31 and determine if one car is approaching another from behind in an unsafe fashion. In FIG. 4, the cars are objects that are traveling in the same direction on a common path where the line-of-sight visibility is restricted.

In FIG. 4, the cars 3 traveling down the ramp 31 include, among others, the cars 3-1, 3-2 and 3-3 all located within one 360° turn of the spiral of ramp 31. The monitors 4-1, 4-2, . . . , 4-8 are located within that 360° turn of the spiral of ramp 31. The car 3-1 has line-of-sight visibility of the next forward car 3-2, but neither the car 3-1 nor the car 3-2 has line-of-sight visibility of the forward car 3-3. In an example, the car 3-3 may have a speed that is much slower than the speed of either or both of the cars 3-1 and 3-2 presenting a possible collision hazard.

In FIG. 4, the congestion regions include arrival points of cars from behind at or near the location of cars that are forward as determined in the direction of travel of the cars. The congestion regions in FIG. 4 are determined relative to each car and each car forward of that car. Typically, the congestion regions are spaced apart by substantial distances. For example, the congestion regions for cars in a garage are typically measured in tens of feet.

FIG. 5 depicts a top sectional view of the spiral ramp of FIG. 4 in the region including one 360° turn of the spiral of ramp 31 including the cars 3-1, 3-2 and 3-3 moving along the common path provided by ramp 31 and moving in the same direction. The car 3-1 is in the field of view of the monitor 4-2, is in the field of view of the monitor 4-3 and is just entering into the field of view of the monitor 4-4. The car 3-1 has a clear line-of-sight view of the next forward car 3-2 and no line-of-sight view of the forward car 3-3. The car 3-2 is in the field of view of the monitor 4-4 and in the field of view of the monitor 4-5. The car 3-2 does not have a line-of-sight view of the forward car 3-4. The car 3-3 is in the field of view of the monitor 4-7 and in the field of view of the monitor 4-6.

In FIG. 4 and the FIG. 5, the monitors 4-1, 4-2, . . . , 4-8 are linked together to detect conditions that are potential for collisions. In one example shown for cars 3-1, 3-2 and 3-3, there is a potential for collisions if the speed of either or both of the cars 3-1 and 3-2 is substantially greater than the speed of the forward car 3-3. When such potential collision conditions exists, the relevant ones of the monitors 4-1, 4-2, . . . , 4-8 signal the potential collision conditions and cause an alarm to be made, for example, auditable and/or visible alarms. The operation of the monitors is according to the operations described in connection with TABLE 2.

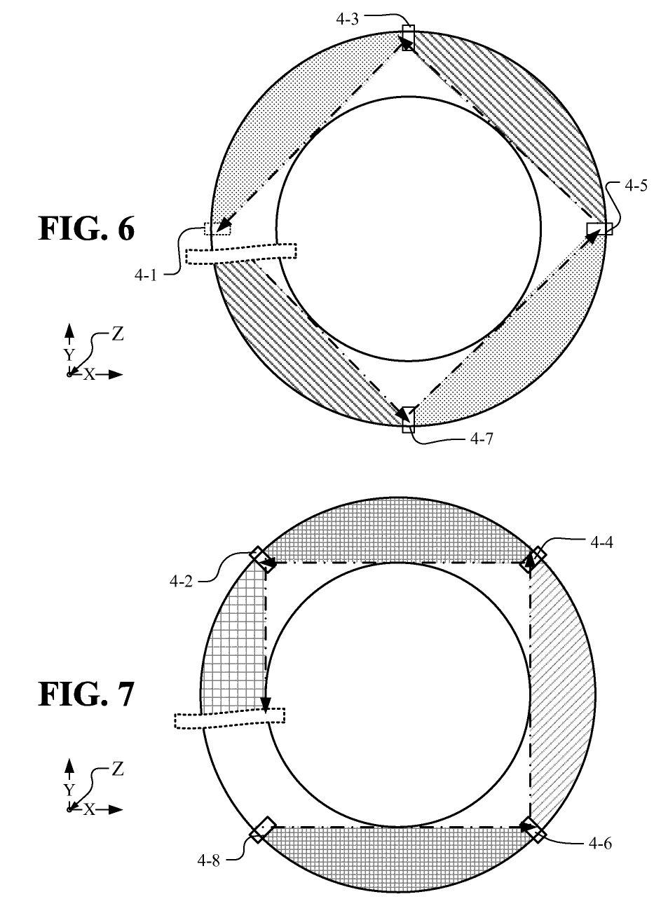

FIG. 6 depicts a top sectional view showing locations of a first set of monitors 4-1, 4-3, 4-5 and 4-7 in the spiral ramp sectional view of FIG. 5. While monitors 4-1, 4-3, 4-5 and 4-7 cover within their fields of view a substantial portion of the ramp 31, there still remains portions that are not within the fields of view of those monitors.

FIG. 7 depicts a top sectional view showing locations of a second set of monitors 4-2, 4-4, 4-6 and 4-8 in the spiral ramp sectional view of FIG. 5. The monitors 4-2, 4-4, 4-6 and 4-8 are positioned to include those portions of the ramp 31 not within the fields of view of the monitors 4-1, 4-3, 4-5 and 4-7 of FIG. 6. Together, the FIG. 6 and FIG. 7 monitors 4-1, 4-2, . . . , 4-8 collectively cover the entire field of view of the 360° turn of the spiral of ramp 31 as described in connection with in FIG. 4 and FIG. 5.

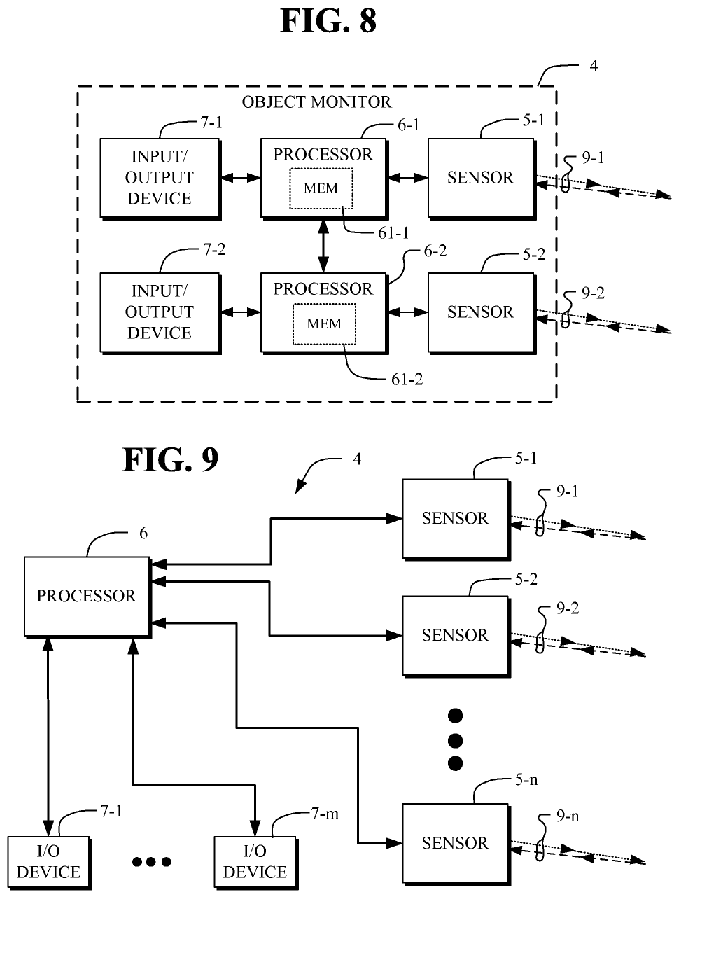

FIG. 8 depicts a block diagram representation of another embodiment of the object monitor 4 of FIG. 1. The object monitor 4 includes a first sensor 5-1 that transmits and receives signals 9-1 where the transmitted signal is to an object and the received signal is reflected back from the object as described in connection with FIG. 1. The object monitor 4 includes a second sensor 5-2 that transmits and receives signals 9-2 where the transmitted signal is to an object and the received signal is reflected back from the object as described in connection with FIG. 1. The transmitted and received signals 9-1 and 9-2 are, for example, the type of signals provided in the GE range-controlled radar motion sensor or the type of signals in the Air Ultrasonic Ceramic Transducer 400ST/R160 transmitter/receiver pair but can alternatively be any other signals that provide position information.

In FIG. 8, the object monitor 4 includes the processors 6, including processors 6-1 and 6-2, which, in one embodiment, are the processors provided in the GE range-controlled radar motion sensors. In alternative embodiments, the processors 6-1 and 6-2 are conventional microprocessors that execute routines for determining the position, velocity and estimated collision times of objects detected by the sensors 5-1 and 5-2, respectively. The processors 6-1 and 6-2 include or are associated with memory 61-1 and 61-2 for storing routines and other information useful in performing the algorithms used for collision predictions of moving objects. The processors 6-1 and 6-2 are interconnected so that they may cooperate in object detection and collision prediction.

In FIG. 8, the object monitor 4 includes input/output devices 7 including I/O devices 7-1, . . . , 7-m. The number “m” of I/O devices can be one or more as the configuration requires. The input/output devices 7 provide manual or automated mechanisms for loading routines and setup information into the processors 6. Also, the input/output devices 7-1 and 7-2 which receive collision prediction and other signals from the processors 6-1 and 6-2, respectively, are used by the input/output devices 7 to sound visual, audible and other alarms warning of predicted collisions and to provide other output information.

A typical operation of the object monitor 4 of FIG. 8 for predicting collisions of the objects is described in connection with the software routines in TABLE 1 and TABLE 2 above.

FIG. 9 depicts a block diagram representation of an object monitor 4 having a common processor 6 with a plurality of sensors 5. The object monitor 4 includes one or more sensors 5, including sensors 5-1, 5-2, . . . , 5-n, that transmit and receive signals 9, including signals 9-1, 9-2, . . . , 9-n, respectively, where the transmitted signals are to objects and the received signal are reflected back from the objects. The transmitted and received signals 9 are, for example, the type of signals provided in the GE range-controlled radar motion sensor or the type of signals in the Air Ultrasonic Ceramic Transducer 400ST/R160 transmitter/receiver pair but can alternatively be any other signals that provide position and velocity information about objects.

In FIG. 9, the object monitor 4 includes a single common processor 6 connected to each of the sensors 5-1, 5-2, . . . , 5-n for determining the position, velocity and estimated collision times of objects detected by the sensors 5-1, 5-2, . . . , 5-n. The processor 6 includes or is associated with memory 61-n for storing routines and other information useful in performing the algorithms used for collision predictions of moving objects.

In FIG. 9, the object monitor 4 includes input/output devices 7 including I/O devices 7-1, . . . , 7-m. The number “m” of I/O devices can be one or more as the configuration requires. The input/output devices 7 provide manual or automated mechanisms for loading routines and setup information into the processor 6. Also, the input/output devices 7 which receive collision prediction and other signals from the processor 6 are used by the input/output devices 7 to sound visual, audible and other alarms warning of predicted collisions and to provide other output information.

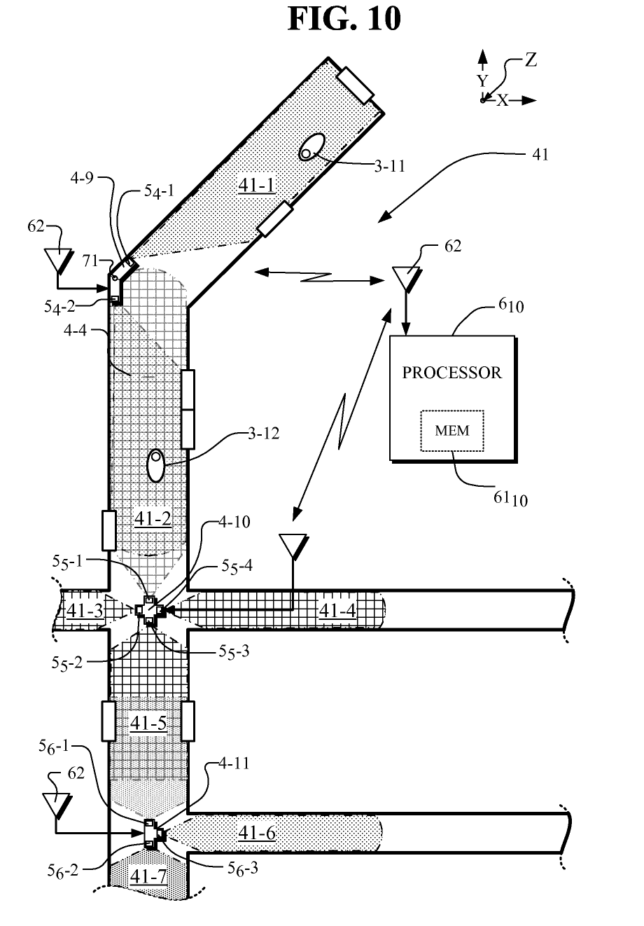

FIG. 10 depicts a block diagram representation of a plurality of object monitors 4, including monitors 4-9, 4-10 and 4-11, located in a hallway 41. The hallway 41 includes the corridors 41-1, 41-2, . . . , 41-7.

In FIG. 10, the two-sensor monitor 4-9 is positioned at the intersection of corridors 41-1 and 41-2. The corridors 41-1 and 41-2 intersect at an angle of approximately 45° and the monitor 4-9 has sensors 5₄-1 and 5₄-2 arrayed at an angle of approximately 45°. The sensor 5₄-1 has a field of view that covers the corridor 41-1 and detects the object 3-11 in the corridor. The sensor 5₄-2 has a field of view that covers the corridor 41-2 and detects the object 3-12 in the corridor. In one embodiment, the monitor 4-9 includes a hinge 71 that allows sensors 5₄-1 and 5₄-2 to be rotated relative to each other and hence to be oriented in different directions. In FIG. 10, the different directions provide field-of-view angles that permit monitoring of the corridors 41-1 and 41-2 that intersect at an angle of approximately 45°. In general, the hinge 71 is of a conventional design that allows adjustment at any angle from 0 degrees to 360 degrees. In addition to hinge 71, each of the sensors 5₄-1 and 5₄-2 includes, in some embodiments, conventional means for further adjustment in any of the X-axis, Y-axis and Z-axis directions. The object 3-11 in the corridor 41-1 potentially will collide with the object 3-12 in the corridor 41-2 if they continue along their travel paths to the intersection of the corridors 41-1 and 41-2. The objects 3-11 and 3-12 are representative of any moving objects such as people that are walking, people on gurneys, people in wheel chairs or people that are otherwise mobile in a hallway 41.

In FIG. 10, the four-sensor monitor 4-10 is positioned at the intersection of corridors 41-2, 41-3, 41-4 and 41-5. The corridors 41-2, 41-3, 41-4 and 41-5 intersect at angles of approximately 90° and the monitor 4-10 has sensors 5₅-1, 5₅-2, 5₅-3, and 5₅-4 arrayed at an monitoring corridors intersecting at approximately 90°. The sensor 5₅-1 has a field of view that covers the corridor 41-2 and detects any objects in that corridor. The sensor 5₅-2 has a field of view that covers the corridor 41-3 and detects any objects in that corridor. The sensor 5₅-3 has a field of view that covers the corridor 41-5 and detects any objects in that corridor. The sensor 5₅-4 has a field of view that covers the corridor 41-4 and detects any objects in that corridor.

In FIG. 10, the three-sensor monitor 4-11 is positioned at the intersection of corridors 41-5, 41-6 and 41-7. The corridors 41-5, 41-6 and 41-7 intersect at angles of approximately 90° and the monitor 4-11 has sensors 5, including sensors 5₆-1, 5₆-2 and 5₆-3, arrayed at angles for detecting objects located in corridors intersecting at approximately 90°. The sensor 5₆-1 has a field of view that covers the corridor 41-5 and detects any objects in that corridor. The sensor 5₆-2 has a field of view that covers the corridor 41-7 and detects any objects in that corridor. The sensor 5₆-3 has a field of view that covers the corridor 41-6 and detects any objects in that corridor. In FIG. 10, the sensors 5 include a first sensor 5₆-1 having a first field of view, a second sensor 5₆-2 having a second field of view and a third sensor 5₆-3 having a third field of view where the second field of view is oriented to detect objects in a corridor at approximately 90 degrees relative to the first corridor and the third field of view is oriented to detect objects in a corridor at approximately 90 degrees relative to the second corridor.

In FIG. 10, the monitor 4-9 with sensors 5₄-1 and 5₄-2; the monitor 4-10-with sensors 5₅-1, 5₅-2, 5₅-3, and 5₅-4; and the monitor 4-11 with sensors 5₆-1, 5₆-2 and 5₆-3 in one embodiment operate together with communication from and to one or more processors 6₁₀. Typically, such communication is through wired connections or through wireless connection links and antennas 62. The wireless connections are, for example, infrared, RF including spread-spectrum and other communication links. The processor 6₁₀ includes or is associated with memory 61₁₀ for storing algorithms of the type described in connection with TABLE 1 and TABLE 2. In alternative embodiments, each of the monitors 4-9, 4-10 and 4-11 operates independently in the manner described in connection with TABLE 1.

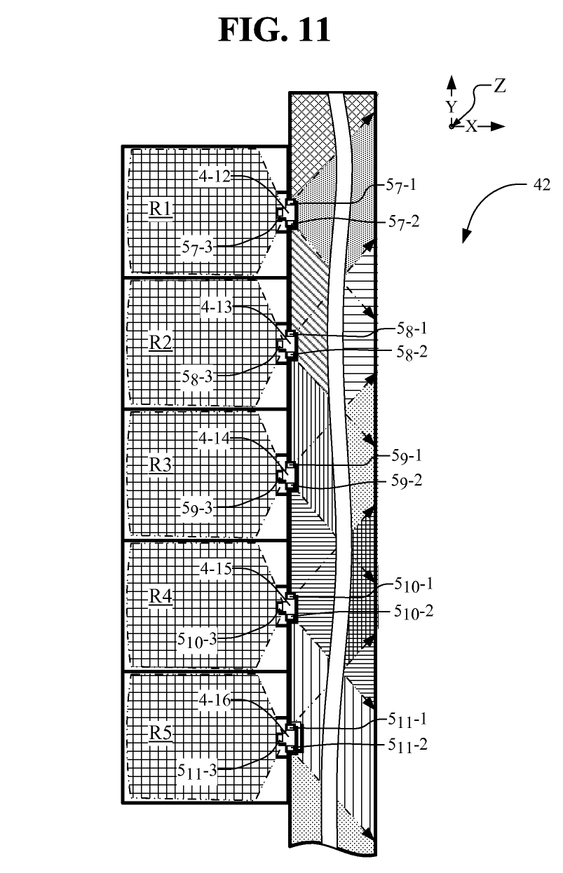

FIG. 11 depicts a block diagram representation of a plurality of object monitors 4, including monitors 4-12, 4-13, 4-14, 4-15 and 4-16, located in doorways to rooms along a hallway 42.

In FIG. 11, the three-sensor monitor 4-12 is positioned between room R1 and the hallway 42. The sensor 5₇-1 has a field of view that covers the corridor 42 in the +Y-axis direction and detects any objects in that direction. The sensor 5₇-2 has a field of view that covers the corridor 42 in the −Y-axis direction and detects any objects in that direction. The sensor 5₇-3 has a field of view that covers the room R1 and detects any objects in that direction.

In FIG. 11, the three-sensor monitor 4-13 is positioned between room R2 and the hallway 42. The sensor 5₈-1 has a field of view that covers the corridor 42 in the +Y-axis direction and detects any objects in that direction. The sensor 5₈-2 has a field of view that covers the corridor 42 in the -Y-axis direction and detects any objects in that direction. The sensor 5₉-3 has a field of view that covers the room R2 and detects any objects in that direction.

In FIG. 11, the three-sensor monitor 4-14 is positioned between room R3 and the hallway 42. The sensor 5₉-1 has a field of view that covers the corridor 42 in the +Y-axis direction and detects any objects in that direction. The sensor 5₉-2 has a field of view that covers the corridor 42 in the −Y-axis direction and detects any objects in that direction. The sensor 5₉-3 has a field of view that covers the room R3 and detects any objects in that direction.

In FIG. 11, the three-sensor monitor 4-15 is positioned between room R4 and the hallway 42. The sensor 5₁₀-1 has a field of view that covers the corridor 42 in the +Y-axis direction and detects any objects in that direction. The sensor 5₁₀-2 has a field of view that covers the corridor 42 in the −Y-axis direction and detects any objects in that direction. The sensor 5₁₀-3 has a field of view that covers the room R4 and detects any objects in that direction.

In FIG. 11, the three-sensor monitor 4-16 is positioned between room R5 and the hallway 42. The sensor 5₁₁-1 has a field of view that covers the corridor 42 in the +Y-axis direction and detects any objects in that direction. The sensor 5₁₁-2 has a field of view that covers the corridor 42 in the −Y-axis direction and detects any objects in that direction. The sensor 5₁₁-3 has a field of view that covers the room R5 and detects any objects in that direction.

In FIG. 11, the monitors 4 and corresponding sensors 5 operate independently in the manner analogous to that described in connection with TABLE 1. Alternatively, the monitors 4 communicate through wired or wireless connection links in the manner described in connection with FIG. 10.

In FIG. 11, one of the monitors 4 may inadvertently sense a signal from a nearby monitor 4 and incorrectly interpret the sensed signal as a reflection of its own signal from an object. To counteract this possibility of false signals, each monitor 4 in some embodiments emits a unique signal readily distinguished from the signals from other monitors. In one such embodiment, each monitor 4 emits a signal pulse that consists of a variable number of cycles. For example, one sensor 5 operating at 40 KHz produces a pulse in the range from 7 to 15 cycles. Each sensor has a different number of cycles to uniquely identify its own reflection when received. At power up or other “listening times”, each of the monitors 4 will “listen” for one or more periods of time, while not producing pulses of its own, to identify possible other monitors 4 in its range. After power up or other listening time, the monitor 4 will use a pulse width with a cycle count that has not been detected during the “listening” time.

In FIG. 11, any one of the monitors 4 may inadvertently sense a signal from a nearby monitor 4 and incorrectly interpret it as a reflection of its own signal from an object. To counteract this possibility, each of the monitors 4 is allocated a unique sequence of pulses that distinguishes it from the sequences of other monitors 4. During operation, a monitor 4 will sequentially emit pulses on each of its sensors 5 and wait a period of time to receive a reflection. A duty cycle is established for each sensor. For example, the duty cycle for a first sensor is 1 out of 2, the duty cycle for a second sensor is 1 out of 3, the duty cycle for a third sensor is 1 out of 4 and so on depending on the number of sensors 5 incorporated in the monitor 4. During an initial period after power-up, or at other synchronization times, each monitor 4 will not emit pulses, but will check for pulses from other monitors 4. If pulses from other monitors 4 are detected, the newly-active monitor 4 will adjust the timing of its own pulses, to occur during the portion of the duty cycle when another monitor 4 is not producing a pulse.

The different embodiments in specification show arrays of object monitors 4. In FIG. 3, for example, the array includes monitors 4-1, 4-2 and 4-3. In FIG. 4, for example, the array includes monitors 4-1, 4-2, . . . , 4-8. In FIG. 10, for example, the array includes monitors 4-9, 4-10 and 4-11. In FIG. 11, for example, the array includes monitors 4-12, 4-13, . . . , 4-16. Each monitor 4 includes one or more sensors 5 for detecting one or more objects on one or more paths. Each sensor detects location values of an object traveling along one of the paths. The array of object monitors 4 includes one or more processors 6. As shown in FIG. 2, the monitor 4 may include the processor 6 as part of an integral unit with the sensors 5 and the I/O device(s) 7. As shown in FIG. 3, the array of monitors 4 may include the processor 6 as a separate unit 6 separate from the array of monitors 4-1, 4-2 and 4-3. In FIG. 8, the processor 6 includes processors 6-1 and 6-2. Irrespective of the locations and numbers of processors, collectively, the processor(s) 6 function to receive first location values of a first object and to calculate a first arrival time of the first object in a congestion region, to receive second location values of a second object and to calculate a second arrival time of the second object in the congestion region, and to provide an alarm signal when the first arrival time and the second arrival time are within a difference value of being equal. The various components of a monitor can be combined in various ways. For purpose of the present specification and claims, the term “monitor” includes any configuration of sensors and processors regardless of how they are distributed.

Typical embodiments of the monitors 4 have been described in connection with TABLE 1, TABLE 2 and TABLE 3 code and processor operations. Other operations of the monitors 4 in addition to those described are implemented with additions to the TABLE 1, TABLE 2 and TABLE 3 processor operations with details that will be understood by those skilled in the art. Some of the examples described in this specification of functions that are implemented with code in TABLE 2 are as follows.

The monitor determines when a potential collision condition has commenced or terminated and responsively commences or terminates an alarm. Additionally, in some embodiments if a potential collision condition has continued for a period of time, the monitor thereafter makes the alarm more imperative by increasing volume, pitch, or the rate of flashing. In some embodiments, the monitor determines when the potential collision condition has stopped for a period of time and thereafter, ramps down the warnings and eventually stops the warnings. (See TABLE 2 commencing line 299).

The monitor controls the logic to provide a “short notice” condition, which appears suddenly when significant risk of collision is present, so as to provide an immediate, imperative and attention-grabbing warning. (See TABLE 2 commencing line 299).

The monitor establishes different priorities for each approach direction. For example, the objects coming from a direction with lower priority are warned before the objects coming from a direction with higher priority. (See TABLE 2 commencing line 270).

The monitor determines which sensors interact with which other sensors. The code executing in the processor is an association control for determining which ones of two or more sensors provide the first location values and the second location values. The code is typically stored in the memory together with control data for specifying associations. (See TABLE 2 commencing line 154).

The monitor assigns each sensor a different warning priority. (See TABLE 2 commencing line 349).

The monitor determines the presence of other monitors and adjusts the time when detections occur to avoid interference with such other monitors. (See TABLE 2 commencing line 250).

The monitor determines the presence of other monitors and adjusts the detection duration to provide uniquely identifiable signals. (See TABLE 2 commencing line 255).

While the invention has been particularly shown and described with reference to preferred embodiments thereof it will be understood by those skilled in the art that various changes in form and details may be made therein without departing from the scope of the invention.

1. An object monitor comprising,
two or more sensors for detecting two or more objects on one or more paths, each sensor for detecting location values of an object traveling along one of the paths,
a processor for,
receiving first location values of a first object and calculating a first arrival time of the first object in a congestion region,
receiving second location values of a second object and calculating a second arrival time of the second object in the congestion region,
providing an alarm signal when the first arrival time and the second arrival time are within a difference value of being equal.

2. The monitor of claim 1 wherein the two or more sensors include two or more fields of view where the two or more fields of view are oriented at different angles relative to each other.

3. The monitor of claim 1 wherein the two or more sensors include a first sensor and a second sensor having a first field of view and a second field of view where the first sensor and the second sensor are mounted with a hinge whereby the first field of view and the second field of view are oriented at different angles relative to each other by rotation about the hinge.

4. The monitor of claim 1 wherein the sensors include a first sensor having a first field of view for viewing along a first path and a second sensor having a second field of view for viewing along a second path oriented approximately 90 degrees relative to the first path.

5. The monitor of claim 1 wherein the sensors include a first sensor having a first field of view for viewing along a first path, a second sensor having a second field of view for viewing along a second path and a third sensor having a third field of view for viewing along a third path where the second path is oriented approximately 90 degrees relative to the first path and the third path is oriented approximately 90 degrees relative to the second path.

6. The monitor of claim 1 wherein the sensors include a first sensor having a first field of view for viewing along a first path, a second sensor having a second field of view for viewing along a second path, a third sensor having a third field of view for viewing along a third path and a fourth sensor having a fourth field of view for viewing along a fourth path where the second path is oriented at a first angle relative to the first path, the third path is oriented at a second angle relative to the second path and the fourth path is oriented at a third angle relative to the third path.

7. The monitor of claim 6 wherein the first angle, the second angle and the third angle are approximately 90 degrees.

8. The monitor of claim 1 further including memory for storing control data and wherein the processor accesses the control data for controlling the operation of the monitor.

9. The monitor of claim 1 including a control for determining which ones of the two or more sensors provide the first location values and the second location values.

10. The monitor of claim 1 further including memory for storing association control data and wherein the processor accesses the association control data for determining which ones of the two or more sensors provide the first location values and the second location values.

11. The monitor of claim 1 wherein one or more sensors includes an ultrasonic transmitter and receiver for transmitting ultrasonic pulses to an object and for receiving reflected ultrasonic pulses from the object.

12. The monitor of claim 1 wherein one or more sensors includes a radar transmitter and receiver for transmitting radar pulses to an object and for receiving reflected radar pulses from the object.

13. The monitor of claim 1 wherein the sensors are oriented for detecting objects traveling in the same direction along a common path.

14. The monitor of claim 13 wherein the common path is a curve.

15. The monitor of claim 1 wherein the sensors are oriented for detecting objects traveling in a hallway and for detecting objects in a room entering the hallway.

16. The monitor of claim 1 wherein an alarm intensity changes as a function of the difference value.

17. The monitor of claim 1 wherein each sensor is assigned a different warning priority.

18. The monitor of claim 1 including a memory for storing control routines and wherein the processor executes the control routines for controlling monitor operation.

19. The monitor of claim 18 wherein the processor in response to a control routine determines the presence of other monitors and adjusts times of detection to avoid interference with the other monitors.

20. The monitor of claim 18 wherein the processor in response to a control routine determines the presence of other monitors and adjusts detection durations to provide uniquely identifiable signals to avoid interference among monitors.

21. The monitor of claim 1 wherein,
a first sensor determines a first distance to a first position of the first object to provide a first one of the first location values and determines a second distance to a second position of the first object to provide a second one of the first location values,
a second sensor determines a first distance to a first position of the second object to provide a first one of the second location values and determines a second distance to a second position of the second object to provide a second one of the second location values,
and wherein the processor,
for each object,
calculates the change in position of the object between the first one and the second one of the location values,
calculates change in time occurring between the first one and the second one of the location values,
calculates the speed of the object,
calculates the estimated time of arrival of the object in the congestion region,
initiates an alarm signal when the estimated time of arrival of the first object is within a difference value equal to the estimated time of arrival of the second object.

22. An array of object monitors wherein,
each monitor includes one or more sensors for detecting one or more objects on one or more paths, each sensor for detecting location values of an object traveling along one of the paths,
the array of object monitors includes one or more processors for,
receiving first location values of a first object and calculating a first arrival time of the first object in a congestion region,
receiving second location values of a second object and calculating a second arrival time of the second object in the congestion region,
providing an alarm signal when the first arrival time and the second arrival time are within a difference value of being equal.

23. An object monitor comprising,
a sensor for detecting location values of an object traveling along a path,
a processor for,
receiving location values of the object and calculating an arrival time of the object in a congestion region,
providing an alarm signal when the arrival time is equal to a difference value.
